(19) United States
(12) Patent Application Publication
(10) Pub. No.: US 2007/0298311 A1
(43) Pub. Date: Dec. 27, 2007

(54) Fuel cell separator

(76) Inventors: Yixin Zeng, Kariya-shi (JP); Katsuhiro Kajio, Anjo-shi (JP)

Correspondence Address: KENYON & KENYON LLP, 1500 K STREET N.W., SUITE 700, WASHINGTON, DC, 20005, US

(21) Appl. No.: 11/812,905

(22) Filed: Jun. 22, 2007

(30) Foreign Application Priority Data
Jun. 27, 2006 (JP) 2006-176594

(51) Int. Cl. H01M 2/18

(52) U.S. Cl. 429/39

(57) ABSTRACT

In a fuel cell separator, reaction gas fluid grooves form a serpentine fuel gas flow path wherein a plurality of parallel flow paths reverse directions at multiple stages, and the ratio of a fluid groove width to a ridge width downstream along the fluid path is larger than the ratio upstream along the path. Furthermore, the ridge area per unit area is larger upstream than downstream along the fluid path. Uniformity inside a fuel cell is as a result enhance, to enable more efficient and stable operation.

### BACKGROUND OF THE INVENTION

1. Field of the Invention

The present invention relates to a separator structure of a solid polymer electrolyte type fuel cell.

2. Description of the Related Art

Referring to FIG. 6, a structure and an operation of a conventional solid polymer type fuel cell will be described. FIG. 6 is a schematic view showing the structure and the operation of a conventional solid polymer type fuel cell. For example, a single cell of a conventional polymer electrolyte fuel cell disclosed in PCT National Publication No. 11-511289 is constituted in such a manner that a membrane electrode assembly 20 (MEA) is held between a fuel separator 30 and an oxidizing agent separator 32. The above membrane electrode assembly 20 (MEA) is prepared by arranging a anode 12 having a catalytic layer 14 and a fuel side diffusion layer 15, and an cathode 16 having a catalytic layer 18 and an oxidizing agent side diffusion layer 19 so that the anode 12 and the cathode 16 face each other on both sides of an electrolyte 10 made of a polymer membrane. Furthermore, gaskets 22, 24 are each held between a separator and the membrane electrode assembly 20.

In many fuel cells, hydrogen is used as the fuel and air containing oxygen is used as the oxidizing agent. Hydrogen, which is the fuel, flows through grooves 34, 36 formed in the fuel separator 30, while the air which is the oxidizing agent flows through grooves 38, 40 formed in the oxidizing agent separator 32. The hydrogen is supplied from the grooves 34, 36 to the fuel side diffusion layer 15 of the anode 12, and then diffuses inside the fuel cell in the fuel side diffusion layer 15 before being supplied to the catalytic layer 14 which faces the grooves 34, 36 and ridges 52, 54. At positions of the catalytic layer 14, electrons are separated from the hydrogen by a function of the catalytic layer 14 to produce hydrogen ions. The separated electrons transfer from the anode 12 through ridges 52, 60, 54, 62 of the fuel separator to the outside. On the other hand, the hydrogen ions transfer through the inside of the electrolyte 10 to the cathode 16. The electrons transferred from the anode 12 to the outside pass through a load 70 connected by a conductor 68 and through ridges 60, 56, 62, 58 of the oxidizing agent separator 32, and enter the cathode 16. Oxygen from the air which is flowing through the grooves 38, 40 of the oxidizing agent separator 32 is supplied to the oxidizing agent side diffusion layer 19. In the oxidizing agent side diffusion layer 19, oxygen also diffuses inside the fuel cell and is supplied to the catalytic layer 18 which faces the grooves 38, 40 and the ridges 56, 58. Then, the electrons supplied from these ridges and the hydrogen ions and the oxygen which have passed through the electrolyte 10 react with each other with the aid of the catalytic layer 18 to produce water on the cathode 16. The resulting water produced by this reaction flows from the cathode 16 through the grooves 38, 40 of the oxidizing agent separator 32, and is then discharged together with the air flowing through the grooves to the outside of the solid polymer electrolyte type fuel cell. In addition, when a power generating reaction occurs in the solid polymer electrolyte type fuel cell, heat is generated. Therefore, to maintain a temperature of the fuel cell within a proper temperature range, both the fuel separator 30 and the oxidizing agent separator 32 are provided with grooves 42, 44, respectively, on the back sides of the grooves through which the fuel and the air flow, and these grooves 42, 44 allows a refrigerant to flow therethrough.

In such a solid polymer electrolyte type fuel cell, the grooves through which the fuel and the air flow on the electrode sides of the fuel separator 30 and the oxidizing agent separator 32 are used for the supply of hydrogen as the fuel and the air as the oxidizing agent to the respective diffusion layers 15, 19. Additionally, the ridges of the respective separators also function as conduction paths for transferring the produced electrons and conducting a current.

On the other hand, the grooves formed in each separator construct long folded flow paths to increase the efficiency of the solid polymer electrolyte type fuel cell. Accordingly, on the upstream side of each gas path, the number of molecules of hydrogen as the fuel and that of molecules of oxygen in the air as the oxidizing agent per unit area are large, so that power generation is relatively large. Conversely, on the downstream side of each gas path, the number of the hydrogen molecules and that of the oxygen molecules per unit area are small, so that the power generation is relatively small. In consequence, the power generation state inside the fuel cell may become nonuniform, which may deteriorate the performance of the fuel cell. Considering these circumstances, PCT National Publication No. 11-511289 discloses a technology for solving the problem of the nonuniform power generation by increasing the porosity of an electrode substrate on a gas downstream side.

For example, each of Japanese Patent Application Laid-open No. 2001-52723 and 2000-311696 describes a separator 100 in which the number of reaction gas flow path grooves 110 of a reaction gas flow path 105 of a reaction gas inlet 102 is decreased towards a reaction gas output 103 as shown in FIG. 7 to prevent the occurrence of wide variations between the number of hydrogen molecules as a fuel and the number of oxygen molecules on an oxidizing agent side per unit area, and a flow velocity of a reaction gas is increased by decreasing the number of reaction gas flow path grooves 110, 120 to promote the discharge of produced water.

However, in the recent solid polymer electrolyte type fuel cell which is run at a high fuel utilization rate and a high air utilization rate, a difference in concentration of the reaction gas further increases between the upstream gas and the downstream gas, such that a noticeable nonuniformity of the power generation per unit area appears. In other words, upstream along the path, where the gas concentration is higher, the number of the molecules of the reaction gas per unit area is large, and, hence, the power generation per unit area is large. Downstream, on the other hand, the gas concentration is low, the number of reaction gas molecules per unit area is small, and the power generation is small. In addition, because the diffusion tendency of the gas from the grooves towards the inside of the diffusion layer is low, the power generation per unit area throughout the downstream portion of the fuel path deteriorates at a rate proportional to or greater than the decrease in the concentration of the reaction gas molecules. This tendency grows more noticeable as the gas concentration further decreases downstream.

Although in the conventional technology described in Japanese Patent Applications Laid-open Nos. 2001-52723 and 2000-311696 referred to above the molecule densities of the reaction gas can be made uniform, the problem downstream, i.e., the problem that power generation is reduced because the diffusion tendency of the reaction gas from the grooves in the inside direction of the diffusion layer is low, is not solved. Hence, the problem of lower power generation per unit area on the gas downstream side is not solved. As described above, the power generation on the downstream side is equal to or less than the decrease in the molecule density of the reaction gas. Therefore, in the conventional technology described in either Japanese Patent Application Laid-open No. 2001-52723 or No. 2000-311696 referred to above, a width of each ridge on the downstream side is excessively large with respect to a generated current and therefore IR drop be caused by an electric resistance becomes small, and conversely the IR drop be caused by resistance on the gas upstream side relatively increases. As a result, an overall imbalance of the electric resistance occurs, and nonuniformity of the power generation disadvantageously increases inside the fuel cell.

### SUMMARY OF THE INVENTION

A first aspect of the present invention is directed to a fuel cell separator which is at least one of a fuel separator attached to a anode of a membrane electrode assembly constituted by holding an electrolyte between the anode and an cathode to supply a fuel fluid to the anode, and an oxidizing agent separator attached to the cathode of the membrane electrode assembly to supply an oxidant fluid to the cathode, the fuel cell separator comprising grooves through which the fluid to be supplied to the electrode flows and ridges which are conductive paths disposed between the grooves and brought into contact with the electrode to conduct a current, wherein a ridge area per unit area of the membrane electrode assembly upstream of the fluid path is larger than a ridge area per unit area of the membrane electrode assembly downstream of the fluid path.

A second aspect of the present invention is directed to a fuel cell separator which is at least one of a fuel separator attached to a anode of a membrane electrode assembly constituted by holding an electrolyte between the anode and an cathode to supply a fuel fluid to the anode, and an oxidizing agent separator attached to the cathode of the membrane electrode assembly to supply an oxidant fluid to the cathode, the fuel cell separator comprising grooves through which the fluid to be supplied to the electrode flows; and ridges which are conductive paths disposed between the grooves and brought into contact with the electrodes to conduct a current, wherein the ratio of a fluid groove width to a ridge width downstream is larger than the ratio of a fluid groove width to a ridge width upstream side.

In the fuel cell separator of the present invention, it is preferable that the fluid grooves form serpentine flow paths in which a plurality of parallel flow paths reverse direction at multiple stages, and the total flow path sectional area of the plurality of parallel flow paths at the downstream stages is less than the total flow path sectional area of the plurality of parallel flow paths at the upstream stages. It is also preferable that the number of fluid grooves at the downstream stages is less than the number of fluid grooves at the upstream stages. It is further preferable that bosses be disposed in inner surfaces of the downstream fluid grooves.

Furthermore, in the fuel cell separator of the present invention, it is further preferable that the ratio of a fluid groove width to a ridge within the first ½ to ⅔ of a total length of each flow path as measured from the upstream end is within the range of 0.5 to 2.5, and the ratio of a groove width to a ridge within the first within the remaining portion of the flow paths is within a range of 2.5 to 5.0.

With the present invention, uniformity of power generation inside a fuel cell can be enchanced (nonuniformity of power generation can be decreased), and the fuel cell works more efficient and stable.

### BRIEF DESCRIPTION OF THE DRAWINGS

FIG. 1 is a plan view showing a fuel gas flow path in a fuel cell separator according to an embodiment of the present invention;

FIG. 2A is a sectional view of an upstream portion of the flow path in the fuel cell separator shown in FIG. 1;

FIG. 2B is a sectional view of a downstream portion of the flow path in the fuel cell separator shown in FIG. 1;

FIG. 3 is a plan view showing an oxidizing agent gas flow path in an oxidizing agent separator of the fuel cell separator according to the embodiment of the present invention.

FIG. 4 is a plan view showing a refrigerant flow path a fuel cell separator according to the embodiment of the present invention;

FIG. 5 is an enlarged view of a portion of a flow path in a fuel cell separator according to another embodiment of the present invention;

FIG. 6 is a schematic view showing a structure and an operation of a conventional solid polymer type fuel cell; and

FIG. 7 is a plan view showing a portion of a flow path in a fuel cell separator according to a conventional technology.

### DESCRIPTION OF THE PREFERRED EMBODIMENTS

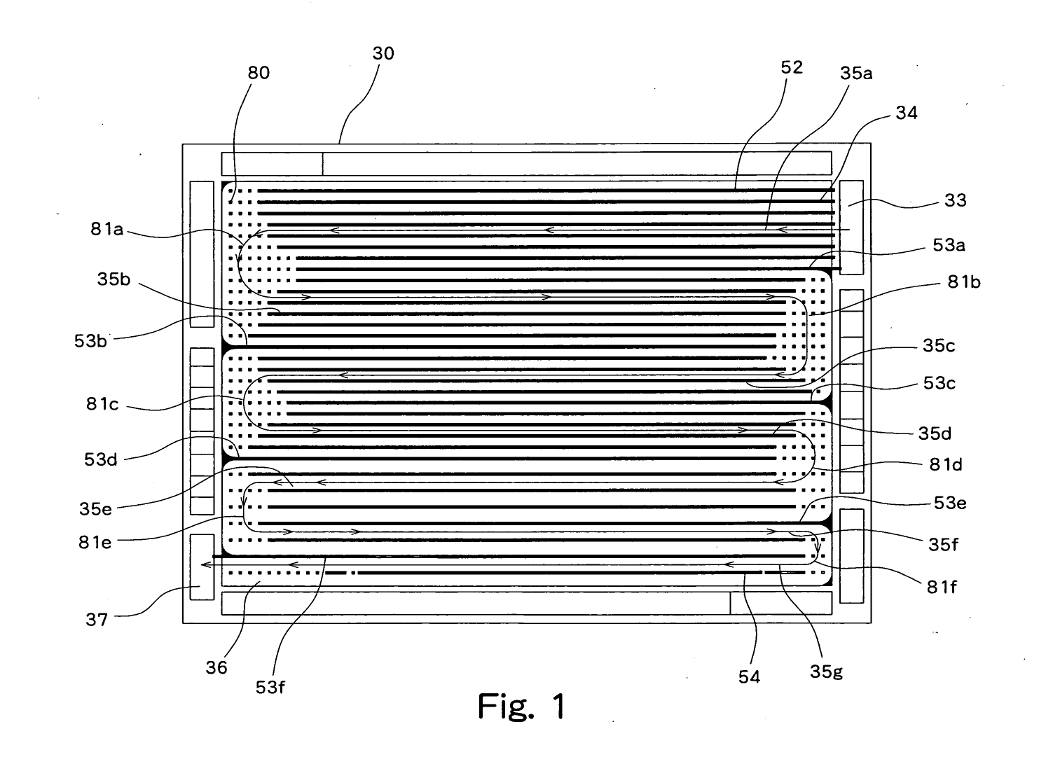

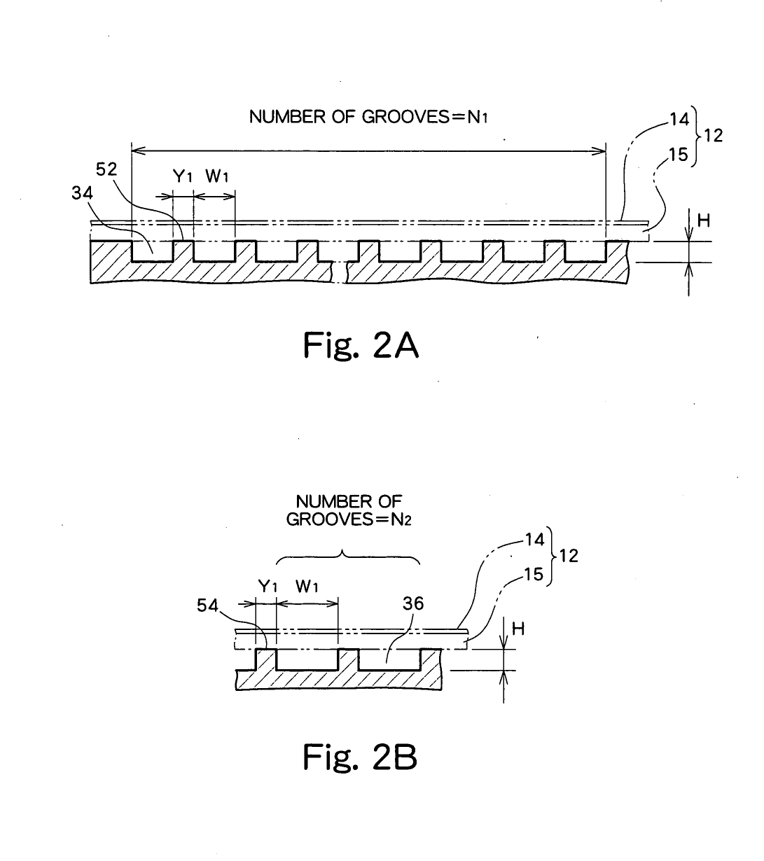

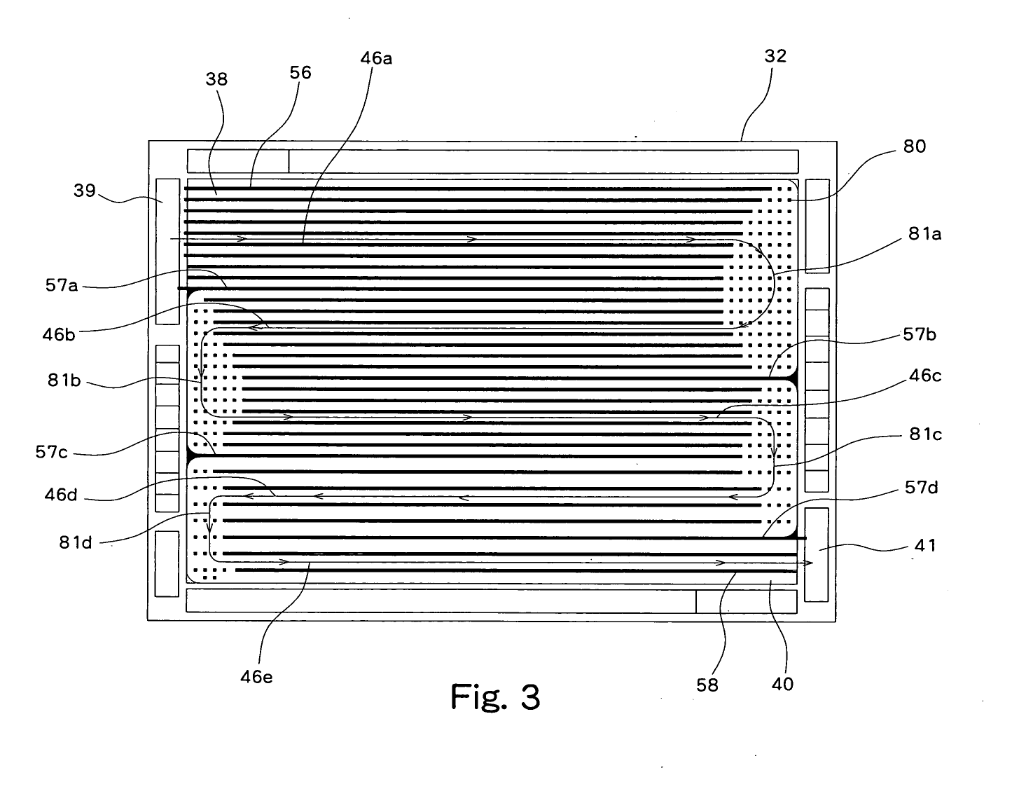

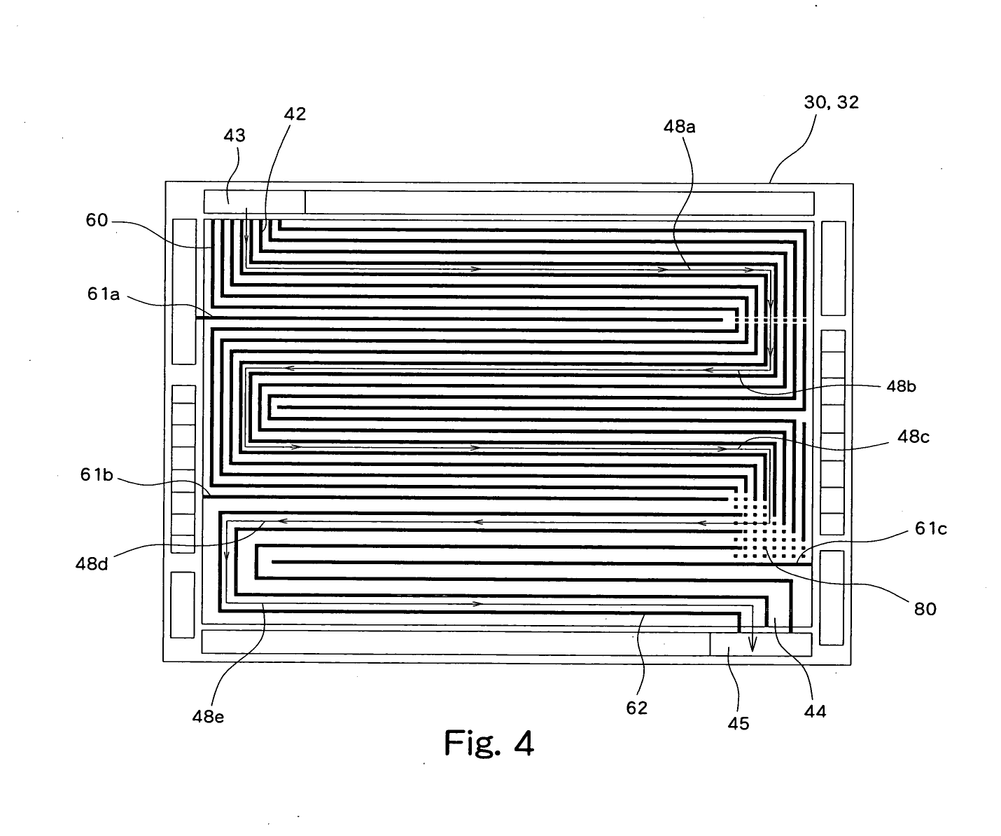

Now, referring to FIGS. 1 to 4, embodiments of the present invention will be described. FIG. 1 is a plan view showing a fuel gas flow path 35 of a fuel separator 30 of a fuel cell separator. FIGS. 2A and 2B are sectional views each showing portions of the flow path in the fuel cell separator. FIG. 3 is a plan view showing an oxidizing agent gas flow path 46 of an oxidizing agent separator 32 of the fuel cell separator. FIG. 4 is a plan view showing a refrigerant flow path 48 on the refrigerant side of the fuel cell separator. Components corresponding to those of the conventional art described above will be denoted by the same reference numerals, and there description will not be repeated.

As shown in FIG. 1, in a fuel electrode side face of the fuel separator 30, grooves 34, 36 forming flow paths through which a fuel gas flows, and ridges 52, 54 which serve as conductors for partitioning the flow paths and supplying a current are alternately arranged. A plurality of parallel fuel gas flow paths 35a to 35g are formed from a fuel gas inlet 33 to a fuel gas outlet 37. The parallel fuel gas flow paths 35a to 35g are formed such that they wind back and forth through a number of serpentine partitions 53a to 53f. Where the flow paths change direction, flow direction changing portions 81a to 81f formed by dimples 80 are disposed. As understood from the above, the fuel gas flow paths are serpentine flow paths in which the pluralities of parallel flow paths change directions at multiple stages.

Each of FIGS. 2A, 2B shows a section of the fuel gas flow path 35. FIG. 2A shows an upstream section of the fuel gas flow path 35a, while FIG. 2B shows a downstream section of the fuel gas flow path 35g. Here, “upstream” essentially refers to the first ⅔ of the flow paths measured from the fuel gas inlet, while “downstream” generally refers to the remaining ⅓ of the flow paths. As shown in FIG. 2A, upstream in the fuel gas path, the width of each groove 34 is W₁, the width of each ridge is Y₁, the number of grooves 34 is N₁, and the depth of the grooves 34 is H. Accordingly, a fuel gas flow path sectional area A₁ of the fuel gas flow path 35a in an upstream section is represented by A₁=W₁×H×N₁. A gas contact length D₁ between the fuel gas and a fuel side diffusion layer 15 in this section is represented by D₁=W₁×N₁. A conductive length E₁ in which the fuel side diffusion layer 15 and the fuel separator 30 come into contact with each other in this section is represented by E₁=Y₁×N₁. Here, the gas contact length D₁ and the conductive length E₁ are orthogonal to the fluid flow direction. Thus, a ratio of the gas contact length D₁ to the conductive lengths E₁ is represented by K₁=D₁/E₁=W₁/Y₁, which is the ratio of the groove width W₁ to the ridge width Y₁ upstream in the fuel gas path.

The upstream ridge width is generally within a range of 0.4 mm to 1.0 mm. The groove width is within a range of 0.4 mm to 2.0 mm. As an example, when the ridge width Y₁ is 0.8 mm and the groove width W₁ is 1.6 mm, a ratio of the groove width W₁ to the ridge width Y₁ is represented by W₁/Y₁=1.6/0.8=2.0.

On the other hand, as shown in FIG. 2B, downstream in the fuel gas flow path 35g, as was the case upstream, a fuel gas flow path sectional area A₂ is represented by A₂=W₂×H×N₂, and a gas contact length D₂ is presented by D₂=W₂×N₂. A conductive length E₂ in which the fuel side diffusion layer 15 and the fuel separator 30 come into contact with each other is represented by E₂=Y₂×N₂, and a ratio K₂ of the gas contact length D₂ to the conductive length E₂ is represented by K₂=D₂/E₂=W₂/Y₂, i.e., a ratio W₂/Y₂ of the groove width W₂ to the ridge width Y₂ on the fuel gas downstream side. Also in this case, the gas contact length D₂ and the conductive length E₂ are orthogonal to the direction fluid flow.

An example of downstream groove and ridge widths similar to the above example of the groove width and the ridge width upstream in the fuel gas path will next be described. When a ridge width Y₂ is 0.8 mm as in the above-described example, a groove width W₂ is set as twice or three times the ridge width Y₂. If the groove width W₂ is three times the ridge width Y₂, the groove width W₂ is 2.4 mm. Thus, in the case of the aforesaid ridge width and groove width, according to the embodiment, the ratio W₂/Y₂ of the groove width W₂ to the ridge width Y₂ along the fuel gas downstream path is 3.0, and the ratio W₁/Y₁ of the groove width W₁ to the ridge width Y₁ along the fuel gas upstream path is 2.0. The ratio W₂/Y₂ of the groove width W₂ to the ridge width Y₂ downstream is greater than the ratio W₁/Y₁ of the groove width W₁ to the ridge width Y₁ upstream.

Upstream in the fuel gas path, the concentration of hydrogen fuel is high, and the density of hydrogen molecules is also high. Therefore, even when a ratio W₁/Y₁ of the groove W₁ to the ridge width Y₁ is about 2.0, the fuel gas supplied from the grooves 34 on the fuel side to the diffusion layer 15 on the fuel side also diffuses into a catalytic layer 14 which face the ridges. In other words, the fuel gas diffuses towards the inside of the fuel cell. In consequence, reaction is promoted in the entire catalytic layer 14 and a voltage distribution of power generation is substantially uniformed inside the fuel cell. On the other hand, downstream along the fuel gas path, as hydrogen fuel is consumed for the power generation, the density of the hydrogen molecules gradually decreases. Therefore, to uniformly maintain the power generation per unit area inside the fuel cell, it is necessary that a flow path sectional area of the fuel gas per unit area of the fuel cell is gradually decreased to increase a flow rate per unit area. Although from the above description it may be expected that, when the sectional area of the flow path is decreased to increase the flow rate per unit area, the number of hydrogen molecules per unit flow path sectional area is maintained in the fuel gas downstream path such that constant power generation per fuel cell unit area would be maintained, in actual practice, however, when the concentration of the hydrogen molecules decreases and the ratio W₁/Y₁ of the groove width W₁ to the ridge width Y₁ is maintained at about 2.0 as in FIG. 2A, there is almost no diffusion of the fuel gas supplied to the diffusion layer 15 from the grooves on the fuel side into portions of the catalytic layer 14 which face the ridges. In other words, the diffusion tendency of the fuel gas towards the inside of the fuel cell is reduced. In consequence, reaction of the portions of the catalytic layer 14 which face the ridges not in direct contact with the fuel gas in the catalytic layers 14 is not promoted, with the result that the voltage distribution of the power generation becomes nonuniform.

While the present embodiment has been described using an example in which the upstream ratio W₁/Y₁ of the groove width W₁ to the ridge width Y₁ is 2.0 and the downstream ratio W₂/Y₂ of the groove width W₂ to the ridge width Y₂ is 3.0, uniformity of power generation per fuel cell unit area may be expected when the upstream ratio W₁/Y₁ of the groove width W₁ to the ridge width Y₁ is within the range of 0.5 to 2.5, and further improved uniformity may be expected when the ratio W₁/Y₁ is preferably from 1.0 to 2.3. If the ratio W₂/Y₂ of the groove width W₂ to the ridge width Y₂ on the fuel gas downstream side is 2.5 to 5.0, the tendency of the fuel gas supplied from the grooves on the fuel side to the fuel side diffusion layer 15 to diffuse into the portions of the catalytic layer 14 which face the ridges is effectively increased, and hence the uniformity of the power generation per fuel cell unit area can be improved. However, to further increase the diffusion tendency and to decrease the nonuniformity of the power generation per fuel cell unit area, the ratio W₂/Y₂ is preferably within the range of 2.7 to 4.0.

The diffusion tendency of the fuel gas in the fuel side diffusion layer 15 varies depending on the ratios of the grooves 34, 36 through which the fuel gas flows to the ridges 52, 54 in contact with the anode 12. In other words, downstream in the fuel gas path, where the number of the hydrogen molecules in the fuel gas is decreasing, the gas diffusion tendency inside the fuel cell increases, as the ratio W₂/Y₂ of the groove width W₂ to the ridge width Y₂ is high. Therefore, even when sectional areas of the flow paths are equal and the numbers of the hydrogen molecules per unit flow path sectional areas are equal, as the ratio W₂/Y₂ of the groove width W₂ to the ridge width Y₂ increases, the diffusion tendency towards the inside increases and the deterioration of the power generation is inhibited. Thus, the uniformity of power generation of the fuel cell per unit area can be further enhanced. Moreover, efficient power generation can be achieved in the downstream portion of fuel cell gas path, where the concentration of the fuel gas is low.

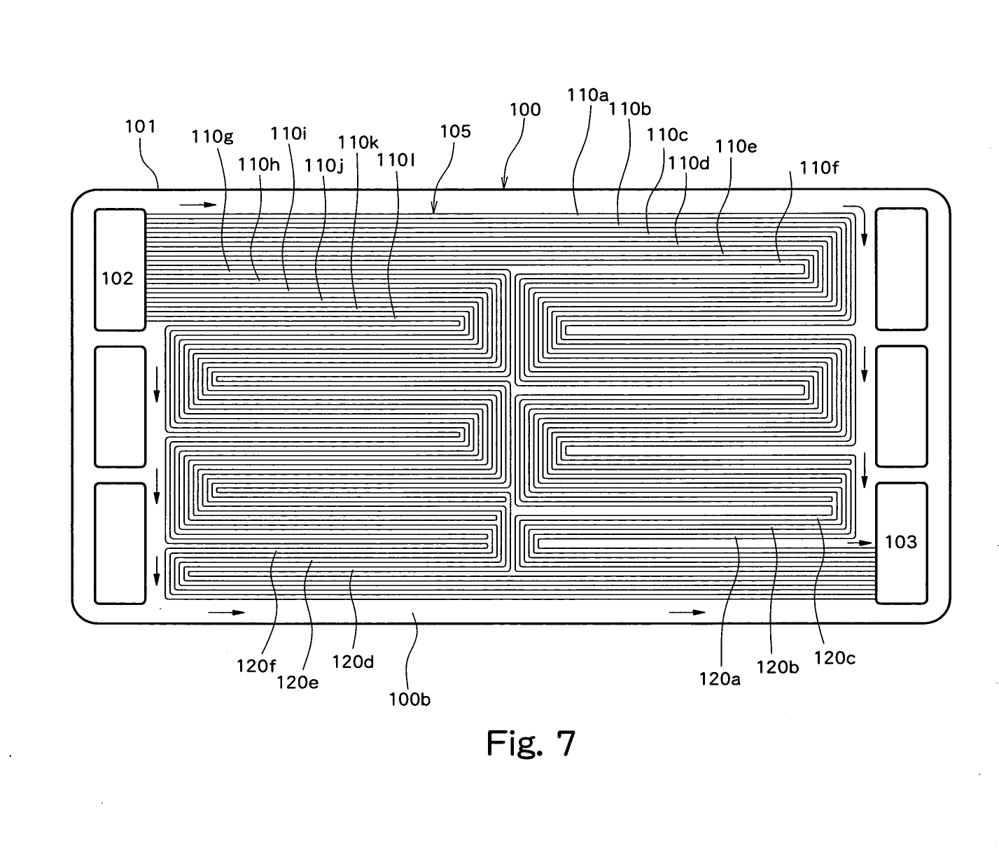

On the other hand, as in the case of the conventional technology shown in FIG. 7, when the number of the grooves is only decreased and the ratio W₂/Y₂ of the groove width W₂ to the ridge width Y₂ downstream in the fuel gas pass is equal to the ratio W₁/Y₁ of the groove width W₁ to the ridge width Y₁ upstream, the diffusion tendency of the fuel gas towards the inside direction of the fuel cell is lower downstream. Therefore, the power generation per fuel cell unit area is lower than in the embodiment of the present invention described above. However, because an area of the ridges which serve as conductive paths to conduct generated electricity outward is larger than that of the embodiment shown in FIG. 2B, an imbalance occurs between an electric resistance and unit power generation. In consequence, the conductive area is insufficient upstream in the fuel gas upstream path, but excessive downstream. However, in the case of a flow path shape shown in FIG. 2B, the conductive area decreases downstream in accordance with the power generation. Therefore, no imbalance between the electric resistance and the unit power generation results, and the power generation inside the fuel cell can effectively be uniformed. Moreover, along the upstream path where the power generation density is high, loss due to the electric resistance is decreased due to the relatively large area of the ridges, thereby further enhancing operational efficiency.

As in the present embodiment, when a configuration is employed in which the ratio W₂/Y₂ of the groove width W₂ to the ridge width Y₂ downstream along the fuel gas path is larger than the ratio W₁/Y₁ of the groove width W₁ to the ridge width Y₁ upstream side, the groove width W₂ of the groove 36 is large and the diffusion tendency from the groove 36 to the fuel side diffusion layer 15 is high, such that the deterioration of the power generation is inhibited, and the ridge width Y₂ of the ridge 54 is not excessive with respect to the power generation. As a result, the balance between the power generation per unit area of the fuel cell and an area of the conductor is maintained, and uniform power generation per unit area of the fuel cell can effectively be ensured. Furthermore, in the fuel gas upstream path where the power generation density is high, the ridges have a larger area. As a result, loss due to the electric resistance on the fuel gas upstream side can be decreased, and operational efficiency enhanced. In addition, also downstream where the fuel gas concentration is low, the ratio W₂/Y₂ of the groove width W₂ to the ridge width Y₂ is large and the diffusion tendency towards the inside direction is high. In consequence, reaction is promoted also in the portions of the catalytic layer 14 which face the ridges, and hence uniform power generation per unit area of the fuel cell can effectively be achieved. Moreover, also in the fuel gas downstream path where the fuel gas concentration is low, efficient power generation can be performed. As long as the condition that the ratio W₂/Y₂ of the groove width W₂ to the ridge width Y₂ in the fuel gas downstream path is larger than the ratio W₁/Y₁ of the groove width W₁ to the ridge width Y₁ in the upstream path (W₂/Y₂>W₁/Y₁) is satisfied, the groove width W₂ may be increased in the downstream path of the fuel gas, or the ridge width Y₂ downstream along the fuel gas path may be decreased, or both, that is, the groove width W₂ may be widened and the ridge width Y₂ also narrowed.

The grooves 34, 36 and the ridges 52, 54 of the fuel separator 30 have been described above. However, as in the case of the fuel gas, also regarding air that is an oxidizing agent gas flowing through the oxidizing agent gas flow path, the density of the oxygen molecules which are the oxidizing agent gradually decreases from the upstream end towards the downstream end. As understood from the above, the oxidizing agent gas flow path 46 is also constituted as in the case of the fuel gas flow path 35, whereby the power generation inside the fuel cell can be made uniform.

As shown in FIG. 3, on an oxidizing agent electrode side face of the oxidizing agent separator 32 are provided alternately arranged grooves 38, 40 constructing flow paths through which an oxidizing agent gas flows, and ridges 56, 58 which serve as conductors for partitioning the flow paths and conducting a current. A plurality of parallel oxidizing agent gas flow paths 46a to 46e are formed from an oxidizing agent gas inlet 39 towards an oxidizing agent gas outlet 41. The parallel oxidizing agent gas flow paths 46a to 46e are constituted so as to wind back and forth through serpentine partitions 57a to 57d. In the winding portions of the flow paths, flow direction changing portions 81a to 81d formed by dimples 80 are disposed. As can be understood from earlier description, as in the case of the fuel gas flow path 35, the oxidizing agent gas flow paths 46 are serpentine flow paths in which the pluralities of parallel flow paths reverse directions at multiple stages. The flow path upstream in the oxidizing agent gas upstream path and the flow path downstream in the oxidizing agent gas path are formed with shapes similar to fuel gas flow paths shown in FIGS. 2A, 2B.

When the flow paths of the oxidizing agent separator 32 and the flow paths of the fuel separator 30 are formed in similar shapes in the above manner, effects of the fuel separator 30 of the present embodiment can be obtained, including the effects that a balance between the power generation per fuel cell unit area and an area of the conductor is maintained such that power generation per unit area of the fuel cell is made uniform; that loss due to an electric resistance on the fluid upstream side can be reduced to enhance the efficiency of operation; that on the downstream side where a gas concentration is low, the ratio W₂/Y₂ of the groove width W₂ to the ridge width Y₂ is large and the diffusion tendency in the inside direction is high, such that reaction is also promoted in portions of the catalytic layer which face the ridges. As a result, uniformity of power generation per unit area of the fuel cell can be further enhanced, and power generation downstream where the gas concentration is low can be made more efficient. As a synergistic result of these effects, the power generation per unit area of the fuel cell can be made more uniform and an efficiency of the power generation can be increased. With the oxidizing agent separator 32, as with the fuel separator 30, as long as the condition that the ratio W₂/Y₂ of the groove width W₂ to the ridge width Y₂ on the fluid downstream side is larger than the ratio W₁/Y₁ of the groove width W₁ to the ridge width Y₁ on the upstream side (W₂/Y₂>W₁/Y₁) is satisfied, the downstream groove width W₂ may be increased, the downstream ridge width Y₂ may be decreased, or both, that is, the groove width W₂ may be widened and the ridge width Y₂ also narrowed. The above embodiment was described using an example wherein, in the flow paths of both of the oxidizing agent separator 32 and the fuel separator 30, the ratio W₂/Y₂ of the groove width W₂ to the ridge width Y₂ downstream along the fluid path was larger than the ratio W₁/Y₁ of the groove width W₁ to the ridge width Y₁ upstream. However, the above effects can be obtained even when the grooves of just one of the oxidizing agent separator 32 and the fuel separator 30 are formed into such a shape. Nevertheless, when the flow path shape of the oxidizing agent separator 32 is constituted so that the ratio W₂/Y₂ of the groove width W₂ to the ridge width Y₂ downstream along fluid downstream path is larger, the balance between the power generation per fuel cell unit area and the area of the conductor can be more effectively maintained, and more uniform power generation per unit area can be achieved than when the flow path shape of the fuel separator 30 is constituted so that the ratio W₂/Y₂ of the groove width W₂ to the ridge width Y₂ downstream along the fluid path is larger than the ratio W₁/Y₁ of the groove width W₁ to the ridge width Y₁ upstream. Additionally, although the above embodiment was described using an example wherein the first ⅔ of the flow from the inlet of the fuel gas towards the exhaust was considered “upstream”, and the remaining ⅓ considered “downstream”, similar effects can be obtained if the range of ½ to ⅔ of the flow paths is considered the upstream range, with the remaining range considered downstream.

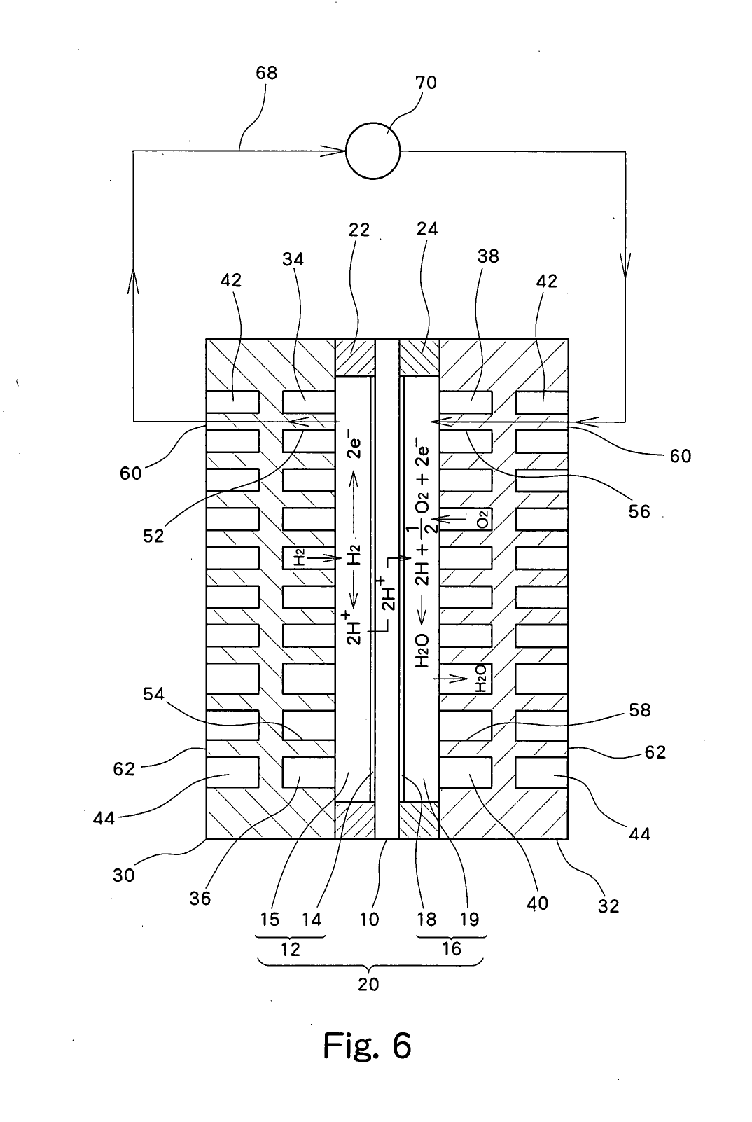

The configuration of the fuel gas flow path 35 and the oxidizing agent gas flow path. 46 formed respectively on the electrode sides of the fuel separator 30 and the oxidizing agent separator 32 has been described. As shown in FIG. 6, in the example embodiment, each separator includes a refrigerant flow path 48 in a surface opposite to the electrode. When the flow paths of the flow path 48 are formed in similar shapes on the electrode sides, conductivity and manufacturing efficiency are improved. Therefore, as shown in FIG. 4, grooves 42, 44 forming the refrigerant flow path 48 and ridges 60, 62 which serve as conductors for partitioning the respective flow paths and conducting a current are alternately arranged, and a plurality of parallel refrigerant flow paths 48a to 48e are formed from a refrigerant inlet 43 to a refrigerant outlet 45. The pluralities of parallel refrigerant flow paths 48a to 48e are constituted so as to reverse direction at serpentine partitions 61a to 61c. Parallel flow paths are formed upstream in each serpentine portion, while flow direction changing portions 81 formed of dimples 80 are provided downstream to uniform the flow of the refrigerant. As can be understood from the above description, the refrigerant flow path 48 is a serpentine flow path in which the pluralities of flow paths reverse directions at multiple stages, as in the case of each of the fuel gas flow path 35 and the oxidizing agent gas flow path 46. When a fuel cell stack is constituted by stacking a membrane electrode assembly 20, the fuel separator 30 and the oxidizing agent separator 32, some of the fuel separators 30 and the oxidizing agent separators 32 may not include the refrigerant flow path 48. However, as long as the flow path of the fuel separator 30 or the oxidizing agent separator 32 is formed with a configuration that the ratio W₂/Y₂ of a groove width W₂ to a ridge width Y₂ downstream is larger than the ratio W₁/Y₁ of a groove width W₁ to a ridge width Y₁ upstream, the above-described effects can be obtained. That is, the balance between the power generation per fuel cell unit area and an area of the conductor can be maintained, and uniform power generation per unit area of the fuel cell can be achieved.

As in the case of each of the fuel separator 30 and the oxidizing agent separator 32, the refrigerant flow path 48 is also formed so that the ratio W₂/Y₂ of the groove width W₂ to the ridge width Y₂ downstream along the fluid path is larger than the ratio W₁/Y₁ of the groove width W₁ to the ridge width Y₁ upstream. Therefore, upstream, where power generation and heat generation are both large, the groove width W₁ is small and the contact area between the refrigerant and the refrigerant wall is large, to thereby increase the cooling capacity. Conversely, in the downstream portions of the fluid path, where power generation and, therefore, heat generation are both smaller, the groove width W2 is large and the contact area between the refrigerant and the refrigerant wall is small, and the cooling capacity is therefore relatively small. In other words, the upstream portion where heat generation is large is provided with a large cooling area, while the downstream portion where the heat generation is relatively small is provided with a smaller cooling area. With this configuration, uniformity of the temperature of the refrigerant inside the fuel cell can effectively be ensured.

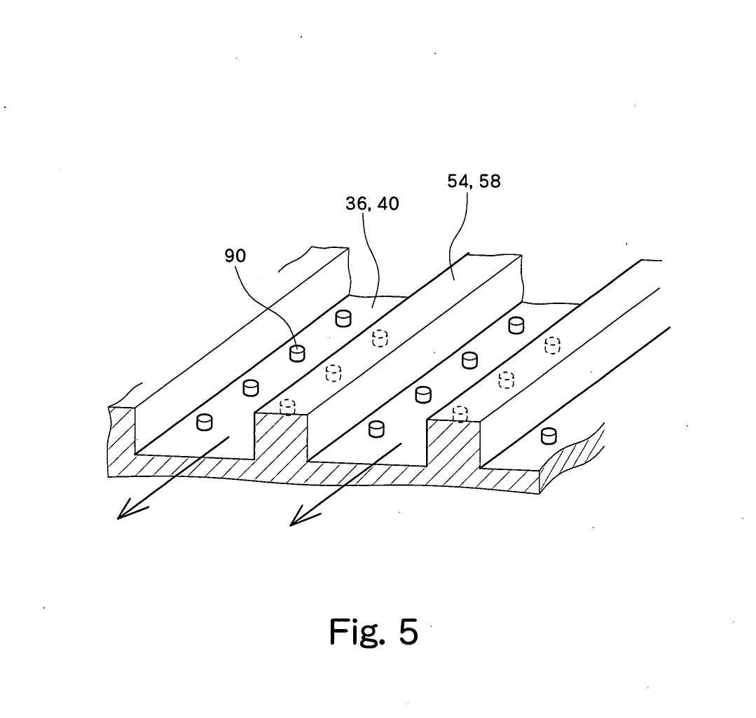

FIG. 5 shows another embodiment of the present invention. In this further embodiment of the present invention, bosses 90 are disposed in each flow path on a reaction gas downstream side to further increase gas diffusion into an electrode on the downstream side. The number of the bosses preferably increases toward an outlet of a reaction gas flow path to enhance the diffusion effect. With respect to the shape of the bosses 90, any of a cylindrical, a columnar and a semispherical shape can be suitably used. As with the above embodiment, with this configuration, uniform power generation of the fuel cell can effectively be ensured.

What is claimed is:

1. A fuel cell separator which is at least one of a fuel separator attached to a anode of a membrane electrode assembly constituted by holding an electrolyte between the anode and an cathode to supply a fuel fluid to the anode, and an oxidizing agent separator attached to the cathode of the membrane electrode assembly to supply an oxidant fluid to the cathode, the fuel cell separator comprising:
grooves through which the fluid to be supplied to the electrode flows; and
ridges which are conductive paths disposed between the grooves and brought into contact with the electrode to conduct a current,
wherein the ridge area per unit area of the membrane electrode assembly upstream along the fluid path is larger than the ridge area per unit area of the membrane electrode assembly downstream along the fluid path.

2. The fuel cell separator according to claim 1,
wherein the grooves form serpentine flow paths in which a plurality of parallel flow paths change direction at multiple stages, and the total flow path sectional area of the plurality of parallel flow paths at the stages downstream along the fluid flow path is smaller than the total flow path sectional area of the plurality of parallel flow paths at the stages upstream along the fluid flow path.

3. The fuel cell separator according to claim 2,
wherein the number of grooves at the stages downstream along the fluid flow path is less than the number of grooves at the stages on the upstream side of the fluid.

4. The fuel cell separator according to claim 3,
wherein bosses are disposed in inner surfaces of the grooves downstream along the fluid flow path.

5. The fuel cell separator according to claim 1,
wherein the fuel separator includes grooves which supply a fluid to a surface opposite to the membrane electrode assembly to cool the separator, and ridges which are conductive paths disposed between the grooves to conduct a current, and
the ridge area per unit area of the membrane electrode assembly upstream along the fluid flow path is larger than the ridge area per unit area of the membrane electrode assembly downstream along the fluid flow path.

6. The fuel cell separator according to claim 1,
wherein the oxidizing agent separator includes grooves which supply a fluid to a surface opposite to the membrane electrode assembly to cool the separator, and ridges which are conductive paths disposed between the grooves to conduct a current, and
the ridge area per unit area of the membrane electrode assembly upstream along the fluid flow path is larger than the ridge area per unit area of the membrane electrode assembly downstream along the fluid flow path.

7. The fuel cell separator according to claim 1,
wherein the ratio of a groove width to a ridge within the first ½ to ⅔ of a total length of each flow path as measured from the upstream end is within the range of 0.5 to 2.5, and the ratio of a groove width to a ridge within the first within the remaining portion of the flow paths is within a range of 2.5 to 5.0.

8. The fuel cell separator according to claim 2,
wherein the ratio of a groove width to a ridge within the first ½ to ⅔ of a total length of each flow path as measured from the upstream end is within the range of 0.5 to 2.5, and the ratio of a groove width to a ridge within the first within the remaining portion of the flow paths is within a range of 2.5 to 5.0.

9. A fuel cell separator which is at least one of a fuel separator attached to a anode of a membrane electrode assembly constituted by holding an electrolyte between the anode and an cathode to supply a fuel fluid to the anode, and an oxidizing agent separator attached to the cathode of the membrane electrode assembly to supply an oxidant fluid to the cathode, the fuel cell separator comprising:
grooves through which the fluid to be supplied to the electrode flows; and
ridges which are conductive paths disposed between the grooves and brought into contact with the electrodes to conduct a current,
wherein the ratio of a fluid groove width to a ridge width downstream along the fluid flow path is larger than the ratio of a fluid groove width to a ridge width upstream along the fluid flow path.

10. The fuel cell separator according to claim 9,
wherein the grooves form serpentine flow paths in which a plurality of parallel flow paths change direction at multiple stages, and the total flow path sectional area of the plurality of parallel flow paths at the stages downstream along the fluid flow path is smaller than the total flow path sectional area of the plurality of parallel flow paths at the stages upstream along the fluid flow path.

11. The fuel cell separator according to claim 10,
wherein the number of the fluid grooves provided at the stages downstream along the fluid flow path is less than the number of the fluid grooves provided at the stages upstream along the fluid flow path.

12. The fuel cell separator according to claim 11,
wherein bosses are disposed in inner surfaces of the fluid grooves downstream along the fluid flow path.

13. The fuel cell separator according to claim 9,
wherein the fuel separator includes fluid grooves which supply a fluid to a surface opposite to the membrane electrode assembly to cool the separator, and ridges which are conductive paths disposed between the fluid grooves to conduct a current, and
the ridge area per unit area of the membrane electrode assembly upstream along the fluid flow path is larger than the ridge area per unit area of the membrane electrode assembly downstream along the fluid flow path.

14. The fuel cell separator according to claim 9,
wherein the oxidizing agent separator includes fluid grooves which supply a fluid to a surface opposite to the membrane electrode assembly to cool the separator, and ridges which are conductive paths disposed between the fluid grooves to conduct a current, and
the ridge area per unit area of the membrane electrode assembly upstream along the fluid flow path is larger than the ridge area per unit area of the membrane electrode assembly downstream along the fluid flow path.

15. The fuel cell separator according to claim 9,
wherein the ratio of a fluid groove width to a ridge within the first ½ to ⅔ of a total length of each flow path as measured from the upstream end is within the range of 0.5 to 2.5, and the ratio of a groove width to a ridge within the first within the remaining portion of the flow paths is within a range of 2.5 to 5.0.

16. The fuel cell separator according to claim 10,
wherein the ratio of a fluid groove width to a ridge within the first ½ to ⅔ of a total length of each flow path as measured from the upstream end is within the range of 0.5 to 2.5, and the ratio of a groove width to a ridge within the first within the remaining portion of the flow paths is within a range of 2.5 to 5.0.
